(19) United States
(12) Patent Application Publication
(10) Pub. No.: US 2007/0167572 A1
(43) Pub. Date: Jul. 19, 2007

(54) Curable dielectric polynorbornene composition and circuit boards made therefrom

(76) Inventors: Alan Keith Wood, Penrith (GB); Richard John Day, Stockport (GB); Martin Allen Williams, King's Laynn (GB); David Hall, Manchester (GB); Cyril Stockil, Mullingar (GB)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 10/549,238

(22) PCT Filed: Mar. 15, 2004
(86) PCT No.: PCT/GB04/01097

§ 371 Date: Jun. 2, 2006

(30) Foreign Application Priority Data
Mar. 13, 2003 (GB) 0305752.8

(51) Int. Cl. C08F 8/00

(52) U.S. Cl. 525/191

(57) ABSTRACT

The present invention relates to a curable dielectric composition comprising polynorbomene, a polymeric diluent that plasticises the composition, a particulate material and a curing agent for the composition. The present invention also relates to a cured form of the curable composition and an electronic circuit board including a cured form of the composition upon which is mounted an electronic circuit.

The present invention relates to dielectric compositions and more particularly to such compositions in both uncured and cured form. The invention relates also to electronic circuit boards having a substrate (on which the circuit is provided) comprised of the cured form of the composition.

Electronic circuit boards, e.g. microwave circuit boards such as used in microwave ovens, mobile telephones, televisions, telecommunications equipment and satellites, generally comprise a dielectric substrate which is provided on at least one side with an electronic circuit which has usually been etched from a copper sheet.

There are several properties that are desired in a substrate for a circuit board.

Ideally the substrate should be sufficiently rigid at relatively low thickness to enable the production of a reasonably sized circuit board.

Also the thermal stability and dielectric properties of the substrate should ideally not vary with temperature as the temperature of an electrical circuit may vary widely in use. Poor thermal stability of the substrate may affect not only its bonding to the conductive circuit(s) but also the stability of the whole circuit may be detrimentally affected. The dielectric constant of the substrate should remain stable and controlled with temperature and a low dielectric loss should be demonstrated over a wide temperature range. Variation of these features detrimentally affect the electronic properties of a circuit board, with the latter feature causing power losses in the circuit.

One example of a substrate used in an electronic circuit board is polytetrafluoroethylene (PTFE).

A problem with the use of PTFE as a substrate is that pure PTFE does not possess the required physical attributes for application in a circuit board and must be strengthened, for example with the incorporation of layers of glass fibre, to find use in this role. The necessary incorporation of layers of glass fibre makes the manufacturing process for the PTFE substrate and an electronic circuit board incorporating same more complex, thus adding to the cost of manufacture

A further disadvantage of PTFE is that as the frequency of the circuit board increases there is a diminution of the ability of the PTFE in reducing interference between two circuits provided on opposite sides of the substrate. Thus whilst it is recognised that PTFE is effective at frequencies of between 0.1-3 GHz, it is not effective at higher frequencies which are now required for use in circuit boards in mobile phones and other telecommunication equipment.

Additionally PTFE has disadvantages arising from its very nature since it is a fluorine-containing compound. Manufacture of fluorine containing compounds is expensive as a result of having to deal with fluorine, which is highly reactive and thus difficult to manage. Destruction of PTFE containing boards by incineration is difficult as this process produces the highly corrosive chemical hydrogen fluoride

To overcome the physical, electronic and disposal problems associated with PTFE substrates comprising other materials have been proposed. Commonly these substrates incorporate a dielectric material, usually in particulate form, to achieve the insulation effect at frequencies higher than 3 GHz. Examples of suitable dielectric materials include silica and strontium titanate.

An example of a substrate that incorporates a dielectric particulate material is described in GB-A-2 204 588 (Rogers Corporation). This prior substrate comprises a thermosetting moulding composition comprised of an admixture of polyisoprene or polybutylene and a cross-linkable thermoplastic elastomer based on either a polyisoprene/polybutylene copolymer or polyethylene/ethylene-propylene copolymer, said copolymer also containing a thermoplastic block. The substrate is prepared by firstly being moulded into the desired shape before being cured. The substrate is described as being suitable for use in microwave circuit boards.

There is however, a problem associated with this prior substrate in that it does not exhibit good temperature stability.

Moreover the physical nature of this material presents difficulties for manufacture and use. The manufacturing route depends heavily on the nature of the components of the substrate. Where continuous-fibrous reinforcements are utilised to provide strength to the substrate, the processes are semi-continuous in that the coating steps are carried out using rolls of reinforcement that can be substantial in length. However, preparation of the coatings and subsequent pressing are batch processes. In the case of substrates that do not contain continuos-fibrous reinforcement, these are manufactured by batch processes. Furthermore when a larger circuit board is required, such as is becoming increasingly commonplace in telecommunication satellites for example, the circuit board must be supported on a suitable base-plate (typically made from aluminium), i.e. it is not self-supporting.

It is an object of the present invention to obviate/mitigate the abovementioned difficulties.

According to a first aspect of the present invention there is provided a curable dielectric composition comprising polynorbomene, a polymeric diluent that plasticises the composition, a particulate material and a curing agent for the composition.

According to a second aspect of the present invention there is provided a cured dielectric composition comprising the cured form of a composition in accordance with the first aspect of the invention.

According to a third aspect of the present invention there is provided an electronic circuit board comprising a conductive circuit mounted on a substrate that comprises a cured composition in accordance with the second aspect of the present invention.

The invention is thus based on the use of polynorbomene to provide curable compositions from which cured dielectric compositions for use as a substrate for an electronic circuit board may be produced.

Polynorbomene is shown below.

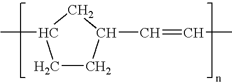

Polynorbomene has a low dielectric constant that does not vary significantly over a large temperature range and also exhibits a low dielectric loss. Both of these properties would ordinarily make the material suitable for use as a substrate in an electronic circuit. However, due to the physical properties of the polynorbomene it has not previously been found possible to produce it in the required form (usually “sheet-like”) for an electronic circuit substrate due to difficulties associated with processing.

What we have found is that an admixture of polynorbomene and a polymeric diluent may be cured to produce a composition that reflects the excellent properties of the polynorbomene yet still allows itself to be readily processed into, for example, a form that is suitable for the substrate of an electronic circuit. Indeed the curable composition has been found to be extrudable into sheet form. The use of extrusion in forming sheets allows the production of circuit boards in a continuous rather than a batch fashion, as it is possible to extrude the composition, e.g. using a sheet extruder. This is in contrast to the processing procedure that has been employed with compositions of the prior art (such as described in GB-A-2 204 588) which required the substrate to be formed in batch fashion using moulds.

Additionally circuit boards in accordance with the third aspect of the present invention have been found to display excellent physical strength properties. These properties improve the general resilience of the circuit board and allow the construction of larger circuit boards than has previously been possible, without necessarily needing another supporting material.

The compositions in accordance with the first and second aspects of the invention display a dielectric constant that is relatively stable across a wide range of temperatures and possesses a low dielectric loss. Therefore electronic circuit boards incorporating such a composition (when cured) as a substrate have predictable (and thus desirable) electronic properties over a large temperature range.

Preferably the polymeric components (i.e. the polynorbornene and the polymeric diluent) comprise from 5-50% by weight of the composition, more preferably from 15-30 wt % and most preferably about 20-25 wt %.

Of the polymeric components it is preferred that the polynorbomene is present in an amount of from 70-85% by weight, more preferably from 72-83 wt % and most preferably from 75-80 wt % of the total amount of the polynorbornene and the polymeric diluent.

A particularly suitable commercially available example of a polynorbomene is Norsorex which is supplied by Atofina of France (previously Nippon Zeon of Japan).

The polymeric diluent may be any polymer which is able to plasticise the polynorbomene in the cured composition. As the diluent is polymeric there are no problems caused by migration thereof within the composition (as would occur with a monomeric plasticiser). Such migration could affect the bonding of the substrate to the circuit board.

It is preferred that the polymeric diluent is present in an amount of from 15-30% by weight of the polymeric components, more preferably from 17-28 wt % and most preferably from 20-25 wt % of the total amount of the polynorbomene and the polymeric diluent.

The polymeric diluent is preferably such that it is co-curable with the polynorbomene. For this purpose the polymeric diluent may include a functional group, such as an unsaturated alkylene group. For preference the polymeric diluent is an elastomer. Generally the elastomer is an ethylene propylene diene (EPDM) which provides an unsaturated group on the diene moiety thereof. A preferred example of an EPDM is where the diene is ethylidene norbomene that is shown below.

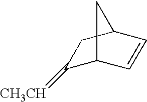

The desired dielectric constant of the compositions in accordance with the invention is provided mostly by the particulate material with the polymeric components providing only a very small contribution to the overall dielectric constant. Generally the particulate material is present in the composition in an amount of from 50-95% by weight, more preferably from 70-85 wt % and more preferably about 75-80 wt %.

Preferably the particle size of the particulate material is from 1-250 μm, with from 60-80 μm more preferred and about 70 μm being most preferred.

The particulate material (or filler) is preferably a ceramic material. Preferred examples of suitable ceramic materials include titania, silica, fused silica, strontium titanate. Admixtures of more than one ceramic material may be used to provide the exact required dielectric constant for the substrate given the required operating frequency of the electronic circuit board. Generally the ceramic material in the composition is selected to be suitable for a circuit board having an operating frequency of between 3 to 20 GHz, with between 3 to 10 GHz being more preferred. As such circuit boards in accordance with the third aspect of the present invention may find use in such applications as mobile phones and other telecommunication equipment such as telecommunication satellites. Circuit boards in accordance with the invention are particularly useful in telecommunication satellites due to the excellent mechanical strength properties of the circuit boards (as described above). This allows the construction and installation of the large circuit boards, which are often required in satellites, without the need to mount the board on a supportive metal (such as aluminium) sheet and minimises any electrical interconnections between separate boards.

Further examples of particulate fillers that may be used include particulate glass, e.g. provided by chopped or milled glass strand.

The (uncured) composition the first aspect of the invention includes a curing agent for effecting cross-linking of the polynorbomene and, depending on its nature, possibly also the polymeric diluent. The amount of curing agent used is selected on the consideration of several factors including the amount of cross-linking required, the speed of the cross-liking reaction and cost. With compositions in accordance with the present invention it has been found that when the curing agent is present in an amount of approximately 5-10% by weight of the polymer an acceptable degree of cross-linking is provided at reasonable speed.

A preferred example of a curing agent is a radical initiator. It is most preferred that the curing agent is able to trigger the curing reaction only on application of the required stimulus of the composition so as to avoid premature curing. In this regard it is most preferred that selective triggering of the curing agent may be achieved by, for example, an elevated temperature or application of radiation (such as ultra-violet radiation). For curable compositions in accordance with the present invention it has been found that peroxides are able to provide these qualities as peroxides are generally fairly heat stable up to around 120-200° C., at which point they decompose to generate radicals. The peroxide is preferably one that is relatively stable at the processing temperature of the compositions that is typically around 140° C. The preferred form of the peroxide is as a pure liquid, not as a dispersion with an inorganic powder or as a mixture with a grease. The other components of any such mixture may interfere with the electrical properties of the substrate and/or may bloom to the surface of the substrate and interfere with the bond between the substrate and the copper cladding. A preferred example of a commercially available peroxide is Akzo Trigonox T101 available from Akzo Nobel.

In addition to the polynorbomene, the polymeric diluent and the particulate material, the compositions of the invention may contain at least one auxiliary agent to achieve desirable properties. Examples of such auxiliary agents include fillers, fire retardant agents and coupling agents to improve the bonding between the fillers and the polymers and the wetting of the fillers by the polymers.

A fire retardant agent is perceived to be particularly desirable to reduce the potential for fire. Examples of fire retardant agents are magnesium hydroxide, aluminium hydroxide, Phosphorus compounds and halogenated additives.

Other additives may include chain extenders such as tri-allyl-cyanurate and similar multi-functional unsaturated chain extenders. These can be used to increase the cross-link density in the final substrate and may act as a process aid.

Generally the coupling agent is silane based, such as chlorosilane and/or aminosilane. Most preferably the silane is used as an admixture, such as 75 wt % chlorosilane and 25 wt % aminosilane. The silane is usually applied to the surface of the filler particles prior to the compounding of the formulation.

In order to produce an electronic circuit board in accordance with the invention it is preferred that the components of the uncured composition (i.e. a composition in accordance with the first aspect of the invention) are fed singly into a twin screw extruder, the feeding position depending on the ingredient. The extrudate is then fed directly into a roller die to produce a continuous sheet of defined thickness, the thickness being slightly in excess of the thickness of the final finished product. The sheet then has a metal layer (usually copper) applied to the surface and the assembly comprising the substrate and the metal layer is loaded into a press for a curing and final sizing process. Subsequently the copper sheet is etched by conventional techniques to produce the desired circuit.

The copper may be applied to the uncured extrudate, under conditions that curing does not occur, in a number of techniques such as vapour deposition (after the substrate has been cured) and compression of a pre-formed sheet onto the substrate.

Whilst it is preferred that the cured substrate is manufactured by a continuous process as outlined above it is also possible in a less preferred embodiment to adopt a batch process. In an example of such a process, pre-prepared pellets of the composition of the first aspect of the invention are fed to a twin roll set mill to make the pellets into a sheet. The nip gap of the twin roll set mill is usually of the order of 0.5 mm, however, this may be increased once a sheet has been formed by the order of around 5% to ensure that the sheet is compressed flat during the pressing stage. The sheet is then transferred to a compression moulding tool and placed in a press to effect the crosslinking reaction (preferably at 160-180° C.). A cured sheet can thus be removed from the mould.

Where the substrate is clad with copper sheet as part of this process, the preferable route is to press the substrate to thickness at a temperature below that at which the cross-linking agent is activated but which was sufficiently high to allow the composition to flow. The pressing process is interrupted, the copper sheet applied and the clad composition pressed again but at a temperature at which the cross-linking agent would decompose, curing thus occurring.

Copper cladding can also be carried out using commercially available bonding films and can also be achieved by electrical deposition methods. These processes would occur after the completion of the curing stage.

Assuming that the polymeric diluent is an EPDM, the following procedure may be used for manufacturing the pellets.

The EPDM is cut into strips and fed into a twin-screw extruder, usually with the extruder close to ambient temperature due to the tacky nature of the EPDM. The EPDM extrudate is mixed with polynorbomene and fed through a twin-screw extruder set at around 120° C., and the extrudate is pelletised using a die-face cutter. These pellets are mixed with the particulate material and the curing agent and fed through a twin-screw extruder. The extrudate is pelletised with a die-face cutter.

It will be appreciated that the pre-prepared pellets may also be used as a feed material in a continuous process in accordance with the invention.

A number of modifications are possible to the methods above.

Examples of such modifications are:
1. Processing all the ingredients through the extruder in a single pass to yield pellets.
2. The ingredients could be fed into the extruder at several points along the barrel, using a side feeder, in order to improve the ease of processing.
3. The liquid peroxide could be pumped directly into the machine rather than being premixed with polymer.

The preferred scheme is one where the ingredients are mixed and shaped in a single operation, the curing process either occurring in-line or separately.

The following non-limiting Examples illustrate the invention.

### EXAMPLE 1

A composition in accordance with the invention was prepared (using the procedure described below) from the following components.

Components

| Grams | Material | Brand | % |
|---|---|---|---|
| 100 | Polynorbornene/EPDM | Norsorex/Vistalon V2504 | 20 |
| | (Mixed ratio 3:1) | | |
| 50 | TiO₂ | RCL 535 | 10 |
| 350 | Fused Silica | Ranco-sil No. 1 45 micron | 70 |
| 10 | Peroxide | Trigonox 101, liquid | 10% of |
| | | | polymer |

The composition was produced by initially mixing the polynorbomene, EPDM and peroxide in a twin-screw extruder (with die head removed). The resultant admixture was the reintroduced into the extruder together and mixed with the fused silica and mixed thoroughly.

This mixture was pre-pressed at 120° C. at a kiss pressure of 50 psi for 2-3 minutes followed by pressing for 30 minutes at a pressure of 170 psi and temperature of 180° C. to effect curing.

The final composition was found to have a Dielectric Constant of 3.51 as measured in accordance with IPC-TM 650 2.5.5.

### EXAMPLE 2

The procedure of Example 1 was repeated using the following components.

Components

| Grams | Material | Brand | % |
|---|---|---|---|
| 100 | Polynorbornene/ | Norsorex/Vistalon V2504 | 20 |
| | EPDM | | |
| | (Mixed ratio 3:1) | | |
| 200 | Glass flakes | Nippon sheet glass Refg 301 | 40 |
| 200 | Fused Silica | Ranco-sil No. 1 45 micron | 40 |
| 10 | Peroxide | Trigonox 101, liquid | 10% of |
| | | | polymer |

The final composition was found to have a Dielectric Constant of 3.56 as measured in accordance with IPC-TM 650 2.5.5.

### EXAMPLE 3

Components

| Grams | Material | Brand | % |
|---|---|---|---|
| 160 | Polynorbornene/EPDM | Norsorex/Vistalon V2504 | 40 |
| | (Mixed ratio 3:1) | | |
| 240 | Chopped strand | PPG Chop Vantage | 60 |
| | | 3450 E-glass (3.2 mm) | |
| 12 | Amino-silane/Choro-silane | Dow Corning | 3 |
| | (Mixed ratio 3:2) | Z-6020/Z.6076 | |
| 11 | Peroxide | Trigonox 101, liquid | 10% of |
| | | | polymer |

The silica mixture was initially evenly distributed over the surface of the filler (the cropped strand) using a spray gun. The treated filler and other components of the formulation were then thoroughly mixed together using a standard food mixer.

The mixture was then cured using the same procedure employed in Example 1.

The resulting composition had a Dielectric Constant of 3.45 (measured in accordance with IPC-TM 650 2.5.5) and a Flex Modulus of 2.4 Gpa.

### EXAMPLE 4

The procedure of Example 3 was repeated using the following components.

Components

| Grams | Material | Brand | % |
|---|---|---|---|
| 215 | Polynorbornene/EPDM | Norsorex/Vistalon V2504 | 30 |
| | (Mixed ratio 3:1) | | |
| 250 | Fused Silica | Ranco-sil No. 4 75 | 34 |
| | | micron | |
| 250 | Milled Fabric | PPG Milled Fibre 9588 | 34 |
| 11 | Amino-silane/Choro-silane | Dow Corning | 2 |
| | (Mixed ratio 3:2) | Z-6020/Z.6076 | |
| 12 | Peroxide | Trigonox 101, liquid | 10% of |
| | | | polymer |

The resulting composition had a Dielectic Constant of 3.58 (IPC-TM 650 2.5.5) and a Flex Modulus of 2.8 Gpa.

### EXAMPLE 5

The uncured dielectric material produced in Example 4 was pressed (in a laboratory press) to a thickness of about 30 mil (i.e. 0.030 inch). The resulting sheet was then laid on top of a brass plate (1.2 mm thick) which had been pre-treated using COBRABOND (to enhance adhesion strength). A layer of copper foil was then placed on the dielectric material.

The assembly was then pressed at 120° C. for 2-3 minutes at a kiss pressure of 50 psi followed by pressing for 30 minutes at 180° C. and 170 psi prior to cooling.

Adhesion of the dielectric material to the brass plate was found to be exceptionally high. The resulting laminate had the following further properties.

| PROPERTY | VALUE |
|---|---|
| Overall Thickness (inch) | 0.06525-0.0666 |
| Dielectric Thickness (inch) | 0.0345-0.035 |
| ¹Dielectric Constant | 3.58 |
| ¹Dielectric Loss | 0.0018 |
| ²Peel Strength of Cu Foil lb/inch) | 3.47 |

¹IPC-TM 650 2.5.5
²IPC-TM 650 2.4.9

1. A curable dielectric composition comprising polynorbornene, a polymeric diluent which plasticises the composition, a particulate material and a curing agent for the composition.

2. A curable composition according to claim 1, wherein the polymeric components comprise between 5-50% by weight of the composition, more preferably 15-30 wt % and most preferably 20-25 wt %.

3. A curable composition according to claim 2, wherein of the polymeric components the polynorbornene, is present in an amount of between 70-85% by weight, more preferably between 72-83 wt % and most preferably between 75-80 wt %.

4. A curable composition according to claim 1, wherein of the polymeric components the polymeric diluent is present in an amount of between 15-30% by weight, more preferably 17-28 wt % and most preferably 20-25 wt %.

5. A curable composition according to claim 1, wherein the polymeric diluent is an elastomer.

6. A curable composition according to claim 1, wherein the polymeric diluent is co-curable with the polynorbornene.

7. A curable composition according to claim 6, wherein the polymeric diluent includes unsaturated alkylene groups.

8. A curable composition according to claim 7, wherein the elastomer is an ethylene propylene diene (EPDM).

9. A curable composition according to claim 8, wherein the diene group of the EPDM is ethylidene norbomene.

10. A curable composition according to claim 1, wherein the particulate material is present in the composition in an amount of from 50-95% by weight, more preferably from 70-85 wt % and more preferably about 75-80 wt %.

11. A curable composition according to claim 1, wherein the particle size of the particulate material is from 1-250 μm, with from 60-80 μm more preferred and about 70 μm being most preferred.

12. A curable composition according to claim 1, wherein the particulate material is titania, silica, fused silica, strontium titanate and/or a mixture thereof.

13. A curable composition according to claim 1, wherein the curing agent is a radical initiator.

14. A curable composition according to claim 1, wherein the curing agent is typically triggered at between 120-200° C.

15. A curable composition according to claim 1, wherein the curing agent is present in an amount of about 5-10% by weight of the polymer.

16. A curable composition according to claim 1, wherein the curing agent is a peroxide.

17. A curable composition according to claim 1, wherein the composition includes at least one auxiliary agent such as a filler, a fire retardant agent and/or a coupling agent and/or a chain extender.

18. A curable composition according to claim 17, incorporating magnesium hydroxide, aluminium hydroxide, phosphorus containing compounds and halogenated compounds as a fire retardant agent.

19. A curable composition in accordance with claim 17, incorporating chlorosilane and/or aminosilane as a coupling agent.

20. A cured dielectric composition comprising the cured form of a composition in accordance with any one of claim 1.

21. An electronic circuit board comprising a conductive circuit mounted on a substrate that comprises a cured composition in accordance with claim 20.

22. An electronic circuit board in accordance with claim 21 wherein the conductive circuit comprises copper.

23. A method of manufacturing a cured composition for use as a substrate for an electronic circuit board, the method comprising continuously forming a sheet of a composition as defined in claim 1 and effecting curing of said composition.

24. A method of forming an electronic circuit comprising producing an assembly which comprises the cured form of a composition as claimed in claim 1 provided with a layer of metal on at least one surface and forming said layer or layers into a circuit.

25. A method as claimed in claim 24 wherein the assembly-is produced by:
(a) forming the uncured composition into a sheet;
(b) applying a metal layer to at least one surface of the sheet; and
(c) effecting curing of the composition.

26. A method as claimed in claim 24 wherein the assembly is produced by:
(a) forming the uncured composition into a sheet;
(b) effecting curing of the composition.
applying a copper layer to the cured sheet by the use of methods such as bonding films and vapour deposition
